(19) United States
(12) Patent Application Publication
(10) Pub. No.: US 2007/0219934 A1
(43) Pub. Date: Sep. 20, 2007

(54) Optical Disc with a Generic Logical Format

(76) Inventors: Bei Wang, Shanghai (CN); Declan Patrick Kelly, Eindhoven (NL); Yang Peng, Shanghai (CN)

Correspondence Address: PHILIPS INTELLECTUAL PROPERTY & STANDARDS, P.O. BOX 3001, BRIARCLIFF MANOR, NY, 10510, US

(21) Appl. No.: 10/580,515

(22) PCT Filed: Nov. 24, 2003
(86) PCT No.: PCT/IB03/05367

§ 371 Date: Oct. 30, 2006

(30) Foreign Application Priority Data
Dec. 12, 2002 (CN) 02156141.9

(51) Int. Cl. G06F 17/30

(52) U.S. Cl. 707/1

(57) ABSTRACT

The present invention provides an optical disc with a generic logical format having a data structure that is defined independent of the content type (i.e., the data type and medium encoding scheme) and the physical medium. In accordance with one embodiment of the invention, a data storage medium is provided for storing data for access by a data processing system. The data storage medium comprises a data structure stored in the medium for describing different data contents stored therein. The data structure includes at least one content object containing data contents, an object definition file associated with the object for describing the object, and an index file including a table of contents having a reference to the object. The generic logical format of the invention can be easily adapted to any new content types without the need to define a complete new format.

### BACKGROUND OF THE INVENTION

The invention relates generally to optical discs, and more particularly to an optical disc with a generic logical format that is independent of the content type and the physical medium.

Optical storage media such as optical discs have been widely used to store different types of media, such as audio, video, data and images. In the development of the optical disc technology, numerous physical and logical disc formats have emerged and commercialized. For example, the physical media have gone through a path from CD to DVD, then to Blu-ray disc and in the future, to other new optical storage media. As to the logic formats of the disc, there are CD-Audio, Picture CD, VCD, SVCD, DVD, etc. The media content types include MPEG1, MPEG2, AC-3, MP3, etc. for the audio formats, and MPEG1, MPEG2, MPEG4, DIVX, etc. for the video formats. Each of these formats is described in lengthy detailed specifications. Player manufacturers have to provide support for each of these formats or suffer from a decline in their market shares. Therefore, any introduction of a new format (physical or logical) is a resource consuming and risky process, which requires close cooperation among the various parties involved, e.g., the content providers, player manufacturers, etc. Further, consumers are forced to buy a new generation of player for each new format introduced, which may not support competing formats. Additionally, the new format may not be supported by all the content providers. As a consequence, it creates a lot of confusions among consumers and significantly increases the thresholds for adopting new formats.

Therefore, there is a need for an optical disc with a generic logical format that is independent of the content type and the physical medium.

### SUMMARY OF THE INVENTION

The present invention provides an optical disc with a generic logical format having a data structure that is defined independent of the content type (i.e., the data type and medium encoding scheme) and the physical medium.

In accordance with one embodiment of the invention, a data storage medium is provided for storing data for access by a data processing system. The data storage medium comprises a data structure stored in the medium for describing different data contents stored therein. The data structure includes at least one content object containing data contents, an object definition file associated with the object for describing the object, and an index file including a table of contents having a reference to the object.

The generic logical format of the invention can be easily adapted to any new content types without the need to define a complete new format. Further, different types of contents can be stored on the same disc and these contents can be either related or unrelated. Moreover, since the generic logical disc format is independent of the physical media, it can be implemented in any existing or future optical disc media such as DVD, Blu-ray disc, etc.

Other objects and attainments together with a fuller understanding of the invention will become apparent and appreciated by referring to the following description and claims taken in conjunction with the accompanying drawings.

### BRIEF DESCRIPTION OF THE DRAWINGS

The invention is explained in further detail, and by way of example, with reference to the accompanying drawings wherein:

FIG. 1 illustrates a generic logical format in an application layer of an optical disc according to one embodiment of the invention; and

FIG. 2 is a flow chart diagram illustrating the operation of a player on an optical disc having a generic logical format according to one embodiment of the invention.

Throughout the drawings, the same reference numerals indicate similar or corresponding features or functions.

### DETAILED DESCRIPTION OF THE PREFERRED EMBODIMENTS

In accordance with the present invention, an optical disc is defined with a generic logic format having a data structure in which the data contents stored on the disc are not limited to a particular data type such as video, audio or data, and the applications or the encoding schemes (e.g., MPEG2, MPEG4, DIVX, etc.) relating to these contents do not have to depend on the physical format of the optical media. This is achieved by making the application layer of the disc independent of the physical layer of the disc. Moreover, the content recognition file usually located in the lead-in area of the disc is moved from the physical layer to the application layer. In this way, different data types of the contents and different applications relating to these contents can co-exist on the same optical disc and interact with each other, independent of the physical format of the disc. Thus, for example, a CD-audio format can be implemented on a DVD disc, and vice versa. Further, existing encoding schemes (e.g., DVD-Video) can be easily implemented on any future optical disc media and other storage media with random access capability, e.g., a hard disk, a flash memory, etc.

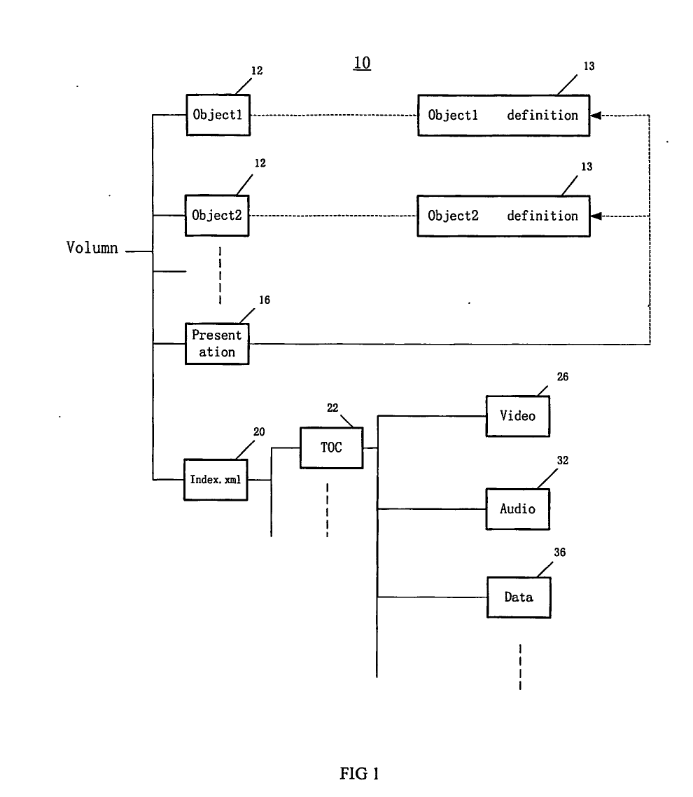

FIG. 1 illustrates a generic logical format 10 in an application layer of an optical disc that is either a recordable disc or a published ROM disc, according to one embodiment of the invention. Generic logical format 10 includes a plurality of content object files 12 containing various data types in different encoding schemes, a plurality of object definition files 13 associated with content object files 12, a presentation file 16 storing the presentation definitions about the objects to be played, and an index file 20 used as a startup file. Index file 20 includes a table of contents (TOC) 22 containing references to different types of files on the disc, e.g., video files 26, audio files 32, data files 36, etc. for linking to content object files 12.

In this embodiment, index file 20 is defined with a meta language, such as XML (eXtensible Markup Language). Furthermore, each of content object files 12 is defined with an associated object definition file 13 including the content title, the content type, the content description, etc. Each object definition file 13 is preferably written in a meta language, e.g., XML. Presentation file 16 includes a menu and a playlist and is written in a meta language, e.g., SMIL (Synchronized Multimedia Integrated Language), for controlling synchronization and timing. This SMIL file can obtain general XML information about content object files 12 from associated object definition files for presenting the content objects on a video screen. Of course, these files do not have to be written in XML or SMIL. Other meta languages including custom-defined meta language may also be used to serve the same purposes.

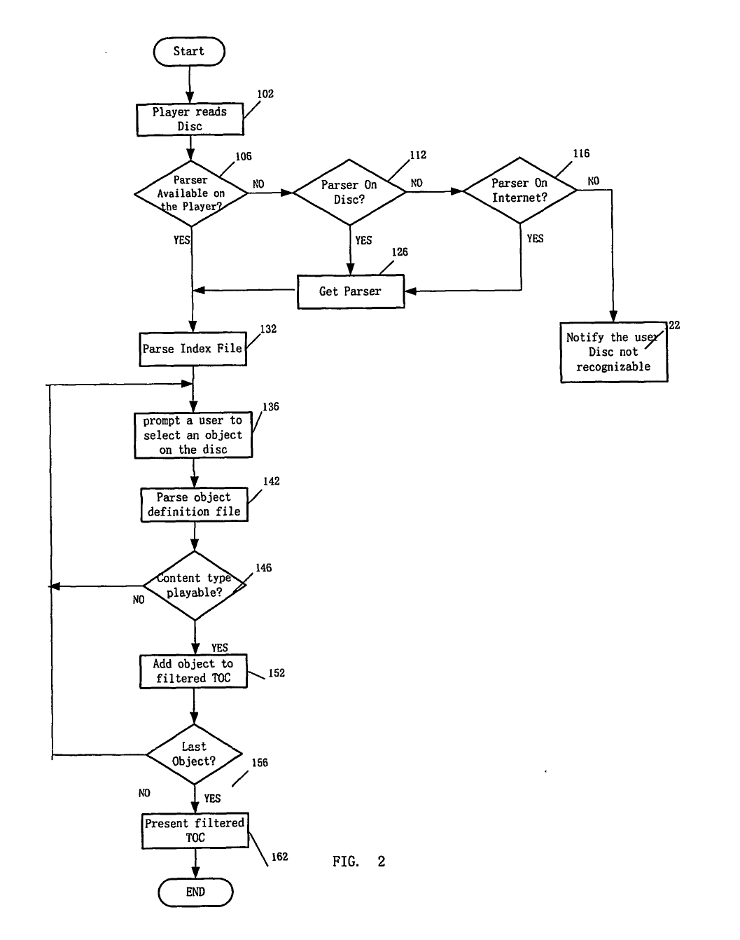

FIG. 2 is a flowchart diagram illustrating the operation of a player on an optical disc having a generic logical format according to one embodiment of the invention. Such a player typically includes a microprocessor. In reading the disc (step 102), the player will determine whether an appropriate parser (e.g., a XML parser) is available on the player (step 106). If an appropriate parser is not on the player, it will determine whether it is available from the disc (step 112) or on the Internet (step 116). If the parser cannot be obtained, the player will notify the user that the disc is not recognizable (step 122) and reject the disc. On the other hand, if the parser is obtainable from either the disc or the network, the player will get the parser (step 126). Once the parser is obtained, the player will parse index file 20 with the parser (step 132) to obtain the TOC. The player will prompt a user to select a content object file 12 from the original TOC on the disc (step 136) and parse the associated object definition file (step 142) to determine whether the content type of the object is playable (step 146). If the object is not playable by the player, the player will prompt the user to select another object and parse the associated object definition file in the same manner. However, if the object is playable, the player includes the object in a filtered TOC stored in the player (step 152) and determines whether this object is the last one on the disc. If it is not the last object on the disc, steps 136 through 156 will be repeated. After all the objects have been parsed, the player will present a filtered TOC with playable contents to the user on a video screen (step 162). The filtered TOC differs from the playlist in the presentation file in that it contains references to only those content objects playable on the particular player.

In this invention, the file system is not required, but may be optionally included in the disc. In such a case, the file system and the index file are independent of each other, and the player can address a content object by using either the file name from the file system or the track number from the index file.

While the invention has been described in conjunction with specific embodiments, it is evident that many alternatives, modifications and variations will be apparent to those skilled in the art in light of the foregoing description. Accordingly, it is intended to embrace all such alternatives, modifications and variations as fall within the spirit and scope of the appended claims.

What is claimed is:

1. A method for creating a data structure in a data storage medium for describing different data contents stored therein, the method comprising the steps of:
creating at least one content object in the medium, the object containing data contents;
creating an object definition file associated with the object in the medium, the object definition file describing the object; and
creating an index file in the medium, the index file including a table of contents having a reference to the object.

2. The method of claim 1, further comprising:
creating a plurality of content objects in the medium; and
creating a presentation file in the medium, the presentation file including presentation definitions of content objects to be played.

3. The method of claim 2, further comprising a step of creating a file system in the medium.

4. The method of claim 2, wherein the presentation file is written in a meta language.

5. The method of claim 4, wherein the meta language includes one of the following: Extensible Markup Language (XML), Synchronized Multimedia Integrated Language (SMIL), and a custom-defined meta language.

6. The method of claim 1, wherein the object definition file is written in a meta language.

7. The method of claim 6, wherein the meta language includes one of the following: Extensible Markup Language (XML), Synchronized Multimedia Integrated Language (SMIL), and a custom-defined meta language.

8. The method of claim 1, wherein the index file is written in a meta language.

9. The method of claim 8, wherein the meta language includes one of the following: Extensible Markup Language (XML), Synchronized Multimedia Integrated Language (SMIL), and a custom-defined meta language.

10. The method of claim 1, wherein the data storage medium is an optical storage medium.

11. A method for creating a logical format in an optical storage medium for describing multimedia data stored therein, the method comprising the steps of:
creating at least one content object on the disc, the object containing data contents;
creating an object definition file associated with the object in the medium, the object definition file being written in a meta language and describing the object; and
creating an index file in the medium, the index file being written in a meta language and including a table of contents having a reference to the object.

12. The method of claim 11, wherein the meta language includes one of the following: Extensible Markup Language (XML), Synchronized Multimedia Integrated Language (SMIL), and a custom-defined meta language.

13. The method of claim 11, further comprising:
creating a plurality of content objects in the medium; and
creating a presentation file in the medium, the presentation file including presentation definitions of content objects to be played.

14. The method of claim 13, further comprising a step of creating a file system in the medium.

15. The method of claim 14, wherein the playlist definition file is written in a meta language.

16. A data storage medium for storing data for access by a data processing system, comprising:
a data structure stored in the medium for describing different data contents stored therein, the data structure including:
at least one content object containing data contents,
an object definition file associated with the object, the object definition file describing the object, and
an index file including a table of contents having a reference to the object.

17. The medium of claim 16, wherein the data structure further comprises a plurality of content objects and a presentation file, the presentation file including presentation definitions of content objects to be played.

18. The medium of claim 17, wherein the data structure further comprises a file system.

19. The medium of claim 18, wherein the playlist definition file is written in a meta language.

20. The medium of claim 19, wherein the meta language includes one of the following: Extensible Markup Language (XML), Synchronized Multimedia Integrated Language (SMIL), and a custom-defined meta language.

21. The medium of claim 16, wherein the object definition file is written in a meta language.

22. The medium of claim 21, wherein the meta language includes one of the following: Extensible Markup Language (XML), Synchronized Multimedia Integrated Language (SMIL), and a custom-defined meta language.

23. The medium of claim 16, wherein the index file is written in a meta language.

24. The medium of claim 23, wherein the meta language includes one of the following: Extensible Markup Language (XML), Synchronized Multimedia Integrated Language (SMIL), and a custom-defined meta language.

25. The medium of claim 16, wherein the data storage medium is an optical storage medium.

26. An optical storage medium for storing data for access by a data processing system, comprising:
a data structure that implements a logical format of the medium for describing multimedia data stored therein, the data structure including:
at least one content object containing data contents;
an object definition file associated with the object, the object definition file being written in a meta language and describing the object; and
an index file being written in a meta language and including a table of contents having a reference to the object.

27. The medium of claim 26, wherein the meta language includes one of the following: Extensible Markup Language (XML), Synchronized Multimedia Integrated Language (SMIL), and a custom-defined meta language.

28. The medium of claim 26, wherein the data structure further comprises a plurality of content objects and a presentation file, the presentation file including presentation definitions of content objects to be played.

29. The medium of claim 28, wherein the data structure further comprises a file system.

30. The medium of claim 29, wherein the playlist definition file is written in a meta language.

31. A disc player for playing back a disc having a logic format that includes at least a content object containing data contents, an object definition file associated with the object for describing the object, and an index file including a table of contents having a reference to the object, the player comprising:
means for parsing the index file to obtain the table of contents;
means for prompting a user to select the object;
means for parsing the object definition file to determine whether the object selected is playable; and
means for playing back the object.

32. The player of claim 31, further comprising means for including the object in a new table of contents if the object is playable.

33. The player of claim 32, further comprising means for presenting the new table of contents to the user.

34. The player of claim 31, wherein the parsing means includes means for obtaining a parser from the disc for parsing the index file if the parser is not available in the player.

35. The player of claim 34, wherein the obtaining means obtains the parser from the Internet if the parser is neither in the player nor on the disc.

36. A method for playing back a disc having a logic format that includes at least one content object containing data contents, an object definition file associated with the object for describing the object, and an index file including a table of contents having a reference to the object, the method comprising the steps of:
parsing the index file to obtain the table of contents;
prompting a user to select the object;
parsing the object definition file to determine whether the object selected is playable; and
playing back the object.

37. The method of claim 36, further comprising a step of including the object in a new table of contents if the object is playable.

38. The method of claim 37, further comprising a step of presenting the new table of contents to the user.

39. The method of claim 36, wherein the parsing step includes a step of obtaining a parser from the disc for parsing the index file.

40. The method of claim 39, wherein the obtaining step includes a step of obtaining the parser from the Internet if the parser is not on the disc.
